(19) United States
(12) Patent Application Publication
(10) Pub. No.: US 2011/0316177 A1
(43) Pub. Date: Dec. 29, 2011

(54) POLYIMIDE PARTICLES DERIVED FROM SCRAP POLYIMIDE FILM AND METHODS RELATING THERETO

(75) Inventor: DAVID HERBERT ROACH, Hockessin, DE (US)

(73) Assignee: E.I. DU PONT DE NEMOURS AND COMPANY, Wilmington, DE (US)

(21) Appl. No.: 12/973,014

(22) Filed: Dec. 20, 2010

Related U.S. Application Data
(60) Provisional application No. 61/288,972, filed on Dec. 22, 2009.

(51) Int. Cl. B29B 9/12

(52) U.S. Cl. 264/13

(57) ABSTRACT

A method is disclosed for making polyimide powder. The method includes feeding polyimide film material into an extruder, where the extruder has at least one heating zone. The feed rate into the extruder is less than the maximum feed rate of the extruder. The material is then extruded for at least 0.5 seconds at a temperature greater than 300° C. to provide a powdered extrudate.

### FIELD OF THE INVENTION

The present invention relates generally to processing scrap polyimide film into a useful material. More specifically, the present disclosure is directed to an economical extrusion process to convert scrap polyimide film into polyimide powder useful in any one of a number of applications, e.g., filler media, sintering media and/or abrasion media.

### BACKGROUND OF THE INVENTION

Scrap polyimide film is difficult to re-use, since it tends to have a high glass transition temperature (Tg), and oftentimes will (partially or wholly) decompose rather than melt. Moreover, pulverizing (e.g., ball milling) scrap polyimide film tends to be unduly expensive in comparison to the value of the resulting powdered material. Hence, scrap polyimide film tends to be land filled, rather than reclaimed. A need therefore exists for an economical method for converting scrap polyimide film into a useful material.

U.S. Pat. No. 6,180,685 to Khait is directed to a method of reconstituting polymeric scrap.

### SUMMARY OF THE INVENTION

The present disclosure is directed to a method for making polyimide powder. The method includes feeding polyimide film material into an extruder, where the extruder has at least one heating zone. The feed rate into the extruder is less than the maximum feed rate of the extruder. The material is then extruded for at least 0.5 seconds at a temperature greater than 300° C. to provide a powdered extrudate. In one embodiment, the extruder residence time is in a range of 2 to 30 seconds and the average temperature during such residence time is greater than 300° C. In one embodiment, during the residence time the material is pre-heated to a temperature of at least 275° C. and the average temperature during such residence time is less than 400° C. In yet another embodiment, the total residence time is less than 20 seconds.

### DETAILED DESCRIPTION OF THE PREFERRED EMBODIMENT(S)

The present disclosure is directed to processing scrap polyimide film into a useful material. The polyimide polymer component of the polyimide film can be any conventional or non-conventional polyimide polymer or polyimide copolymer. In one embodiment, the polyimide film can comprise components other than polyimide polymer in an amount up to 0, 1, 2, 3, 5, 7, 10, 12, 15, 20, 25, 30, 35, or 40 weight percent of the scrap polyimide film. Such other components can be processing aids, colorants, fillers, other polymers or polymeric materials and the like. In one embodiment, the scrap polyimide film can be of any width and has a thickness within a range from about 2 to about 500 microns.

In one embodiment, the processes of the present disclosure require no pre-processing of the scrap polyimide film. In some embodiments, the scrap polyimide film is slit to smaller film dimensions for ease in handling and/or to accommodate extruders that would otherwise lack capacity and/or power to process the scrap polyimide film.

The processes of the present disclosure include an extrusion step. The type of extruder is not limiting and any conventional or non-conventional extruder could potentially be used in accordance with the present disclosure. One example of an extruder is a 16-mm Prism extruder (Prism, Staffordshire, UK) having five heatable zones. In one embodiment, the machine setting on the first (pre-heating) zone can be about 275° C. In one embodiment, the fifth (downstream) zone of the Prism extruder, usually present as a heated die, can be removed and replaced with an unheated 1.5-inch (3.8 cm) tip to protect the operator from sharp edges and moving parts. The remaining three zones can be set so that the scrap polyimide film can be subjected to measured temperatures between about 300 and 425° C. In such an embodiment, the throat of the extruder can be cooled with room temperature (about 20° C.) water, but generally air need not be excluded from the throat. In this particular embodiment, a “Vacuum Extraction” screw series can be used, and the screw can have the following sections: 3 deep feed sections, 8 regular conveying sections, 7 paddles @ 30° (kneading sections), 5 paddles @ 60° (kneading sections), 1 regular conveying section, 1 reverse (left hand) section, 2 regular conveying sections, 10 paddles @ 60° (kneading sections), 3 regular conveying sections and a 1 1.5-inch (3.8 cm) diameter tip. In this particular example, the ratio of the length to the inner diameter of the extruder is about 25. The extrudate can be caught in bins, and room temperature (approximately 20° C.) air can be blown over it to cool it. In this particular example, the temperature to which the scrap polyimide film is subjected can be measured (as distinct from the machine setting) at the three middle zones (zones 2, 3, and 4) of the extruder. Residence times can be calculated from M. Xanthos, “Reactive Extrusion Principles and Practice”, pp. 222-225, Oxford University Press, 1992.

In one embodiment, the scrap polyimide film is fed directly into an extruder. The extruder temperature is maintained (by adding or removing heat) in a range between and optionally including any two of the following temperatures: 300° C., 325° C., 350° C., 275° C., 400° C., and 425° C. In one embodiment, the total residence time of the polyimide film in the extruder is in a range between (and optionally including) any two of the following: 3, 5, 7, 10, 12, 15, 20 and 22 seconds. Use of slower extruder speeds (rpm) and therefore longer total residence times will tend to cause the process to be run at lower temperatures within the above ranges to form the final powder without degradation. Even at short total residence times, about 3.5-5 seconds, the average temperature generally should be at least 1, 2, 3, 4, 5, 6, 7, 8, 9, 10, 12, 15, or 20 degrees (Centigrade) less than the decomposition temperature of the polyimide film.

Optionally, the first heating zone of the extruder can be used as a pre-heating zone (for example at a machine setting of about 250° C.), and the average temperature to which the polyimide film is subjected can then be measured in subsequent heating zones. In the processes of the present disclosure, the scrap polyimide film is fed to the extruder at less than the maximum feed rate that the extruder is capable of processing, so the extruder is slightly “starved”. If too much material is fed to the extruder, the resulting extrudate will tend to clump, and an excessive rise in extruder torque can be created.

The finely divided polyimide particulate made by the processes of the present disclosure can be blended into other polymers as a high temperature particulate filler. Alternatively, the particulate can be used as a sintering agent to create sintered polyimide based parts or objects. In some embodiments, the polyimide particulate may be passed through the extruder to further reduce the particle size.

In yet another embodiment, the particulate made from the processes of the present disclosure is used as a high temperature polymeric abrasion medium. For example, the particulate can be used as a purge medium for extrusion processes. In such an application, the purge step can be performed at temperatures 2, 5, 10, 15, 20 or more degrees (Centigrade) below the decomposition temperature of the polyimide particulate. At such temperatures many conventional extruded polymeric materials soften or melt and can be readily removed by the particulate purge media of the present disclosure. Conventional high temperature purge media tend to comprise inorganic particles which can high temperature resistance but are also tend to be highly abrasive during the extruder purge. The polyimide particulate of the present disclosure generally has sufficient heat resistance at conventional purge temperatures, but is generally much less abrasive compared to conventional inorganic particles, e.g., inorganic oxides, nitrides, carbides and/or the like.

The pulverized particulates tend to have a rounded shape and smooth surfaces which are suggestive of a solid state shearing phenomenon. Depending upon the type of extrusion process selected, the powdered material can have a size (in at least one dimension) of less than about 500, 250, 100, 50, 25, 10, 5, 2, 1, 0.75 or 0.50 microns. The size range of a particular recycled polymeric powder produced by the invention will depend on the screw configuration, and the pulverization parameters employed, such as pulverization temperatures, pressures, screw rpm, and feed rates. The present disclosure is not to be construed as limited to any particular type or sequence of screw elements and barrel sections.

While the invention has been described in terms of specific embodiments thereof, it is not intended to be limited thereto but rather only to the extent set forth hereafter in the following claims.

What is claimed is:

1. A method for making polyimide powder comprising:
(a) feeding polyimide film material into an extruder having at least one heating zone, the feed rate being less than the maximum feed rate of the extruder; and
(b) extruding the material for at least 0.5 seconds at a temperature greater than 300° C. to provide a powdered extrudate.

2. A method in accordance with claim 1, said method having an extruder residence time in a range of 2 to 30 seconds and an average temperature during such residence time of greater than 300° C.

3. A method in accordance with claim 2, wherein during said residence time the material is pre-heated to a temperature of at least 275° C. and the average temperature during such residence time is less than 400° C.

4. A method in accordance with claim 3, wherein the total residence time is less than 20 seconds.
